(19) United States
(12) Patent Application Publication
(10) Pub. No.: US 2011/0057405 A1
(43) Pub. Date: Mar. 10, 2011

(54) Garbage can caddy

(76) Inventor: Frederick Filasky, Jericho, NY (US)

(21) Appl. No.: 12/807,564

(22) Filed: Sep. 8, 2010

Related U.S. Application Data
(60) Provisional application No. 61/276,281, filed on Sep. 10, 2009.

(51) Int. Cl. B62B 5/00

(52) U.S. Cl. 280/79.5

(57) ABSTRACT

A garbage can caddy that can store a number of cans within the caddy. The caddy has preferably a bar shaped frame with a bottom surface and has wheels below serving as a dolly for transporting the cans within the caddy. Flip bars are provided to lock the cans in place or to release them from the caddy structure. A canopy can be attached to the caddy and the flip bar to cover the can tops. The canopy can be made of canvas or any other suitable material. The canopy can be attached to the flip bar and close or open with the rotational movement of the flip bar in one of the two rotational directions of the flip bar with respect to the dolly of the caddy.

### RELATED APPLICATIONS

This is a non-provisional application of provisional application Ser. No. 61/276,281 filed on Sep. 10, 2009 by Frederick Filasky.

### BACKGROUND

The present disclosure relates to a device for storing garbage cans. In particular, the present disclosure relates to a garbage can caddy that stores garbage cans in preferably a wheeled dolly with preferably two flip bars that lock the cans in place inside the caddy and permits each can be removed and re-deposited easily within the caddy. The caddy permits the cans to be moved within the wheeled caddy to and from the curb for pick up by sanitation truck. The caddy preferably includes a covering such as a canopy that can be made of canvas or any other suitable material. The canopy can be attached to the flip bars and close or open with the rotational movement of the flip bar in a respective one of the two rotational directions of the flip bars with respect to the caddy.

### Field

Garbage cans need to be brought out for pick up at the curb in most suburban communities. Wind can knock the cans over and spill the contents even when the lid is sealed. It would be preferable to provide a mechanism that provides for easy storage and transportation of the garbage to and from the curb and which would ensure that the garbage cans do not spill or be knocked over by wind or animals such as raccoons, etc.

### SUMMARY

The present disclosure relates to a garbage can caddy that can store a number of cans within the caddy, i.e. up to 4 or more cans. The caddy is preferably a bar shaped frame with a bottom surface and has wheels below serving as a dolly for transporting the cans within the caddy. Two flip bars are preferably provided to lock the cans in place or release them from the caddy structure. A canopy can be attached to the caddy and the flip bars to cover the can tops. The canopy can be made of canvas or any other suitable material. The canopy can be attached to the flip bar and close or open with the rotational movement of the flip bars in one of the two rotational directions of the flip bar with respect to the dolly of the caddy. The flips bars are rotated in a first direction to release the garbage cans and open the caddy and are rotated in a second direction to lock or close the cans in the caddy.

### BRIEF DESCRIPTION OF THE DRAWINGS

FIG. 1 is an side view of an embodiment for the present disclosure showing the flip bars in a closed position and one or more cans mounted on the caddy bearing swivel wheels;

FIG. 2 is side view similar to FIG. 1 with the flip bars placed in an open position for removal of the cans from the caddy;

FIG. 3 is a front view of the present disclosure of the caddy in FIG. 1 with the flip bars in the locked position;

FIG. 4 is a view similar to FIG. 3 with the flip bars flipped over to the open position;

FIG. 5 is a side view of the present disclosure;

FIG. 6 shows an embodiment for the present disclosure with a caddy adapted to house three garbage cans and having a covering attached to the flip bars;

FIG. 7 shows the canvas covering the cans;

FIGS. 8 and 9 show a certain embodiment of the present disclosure in which a parking brake type mechanism is included to prevent the caddy from moving.

### DETAILED DESCRIPTION OF THE PREFERRED EMBODIMENT(S)

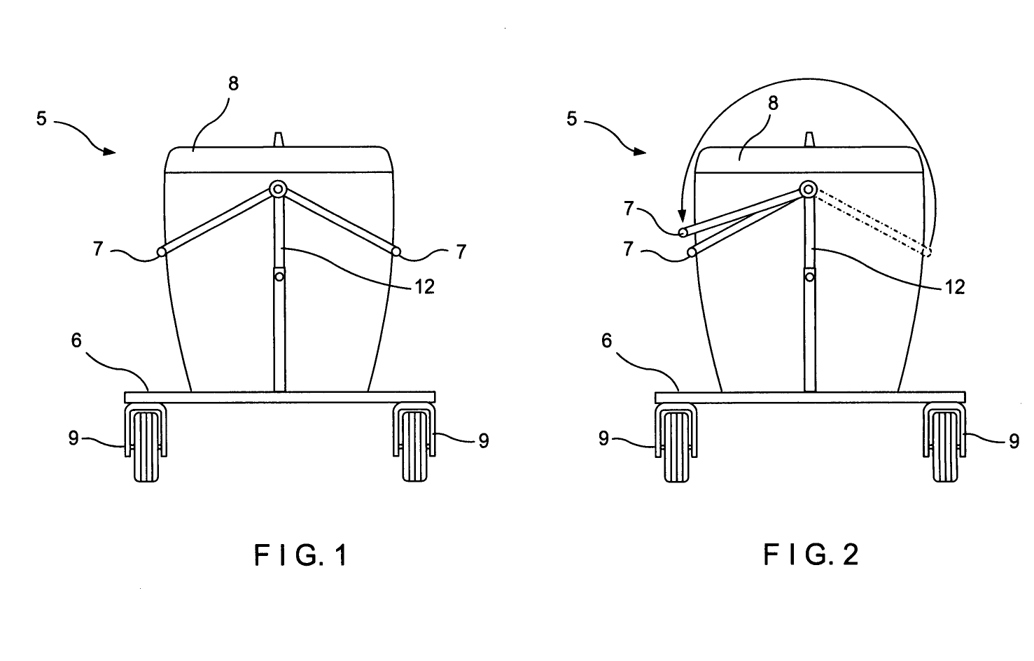

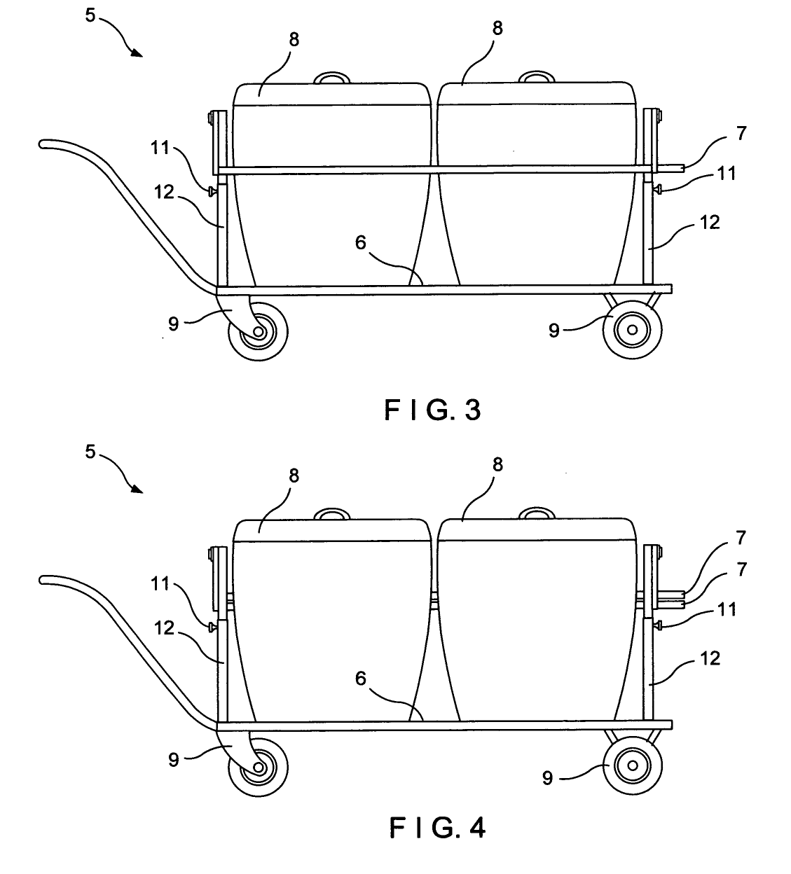

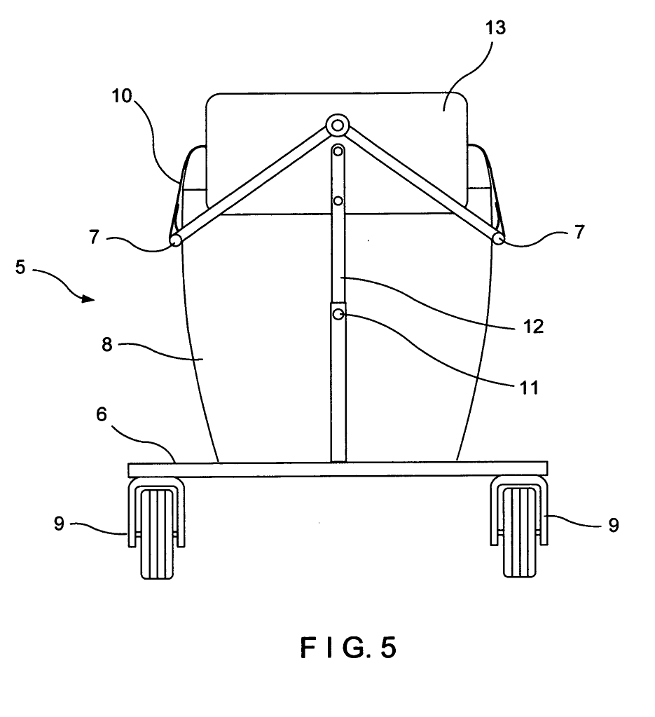

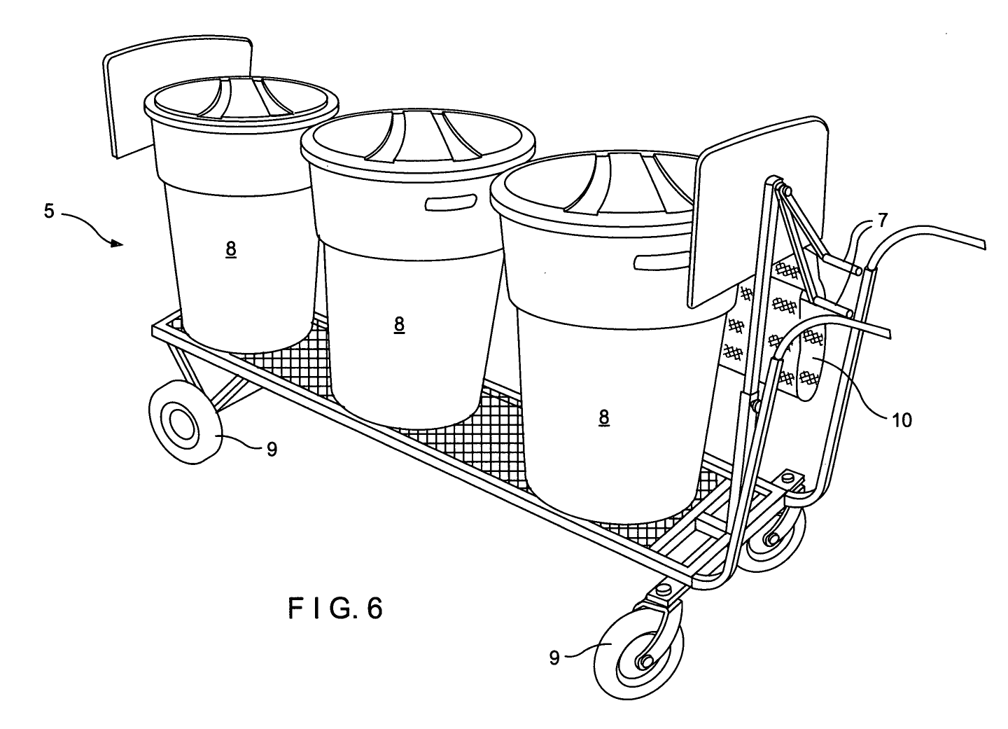

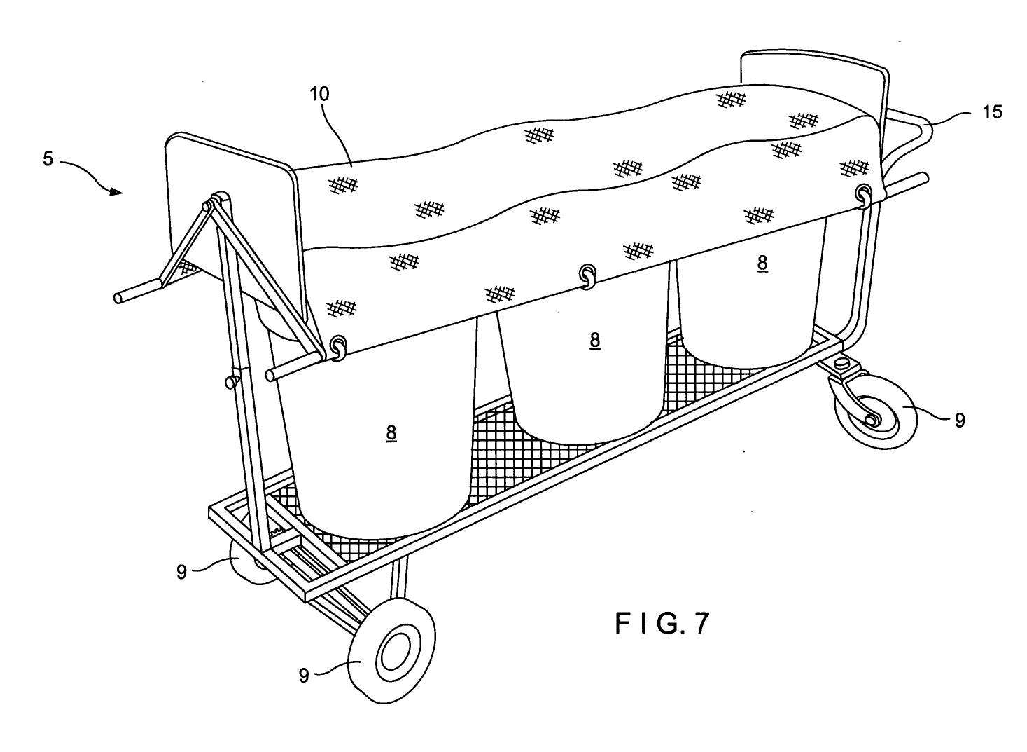

Referring to the drawings, FIG. 1 shows an embodiment of the present disclosure in which the caddy 5 is formed of a frame 5, preferably made of stainless steel material, although plastic material or any suitable material can also be used. The caddy has a bottom surface 6 and the frame 5 can house the garbage cans 8 therein which is readily and easily removable from the top of the caddy. Flip bars 7 can be rotated from a locked position (FIGS. 1 and 4) or to an open position (FIGS. 2 and 3) or vice verse. When in the locked position, the garbage cans 8 are maintained in place and cannot be removed. When in the open position, the garbage cans 8 can be removed from the caddy 5. The caddy 5, which can be a dolly, has swivel wheels 9 on its bottom surface to permit the caddy with the cans inside of the caddy to be easily moved to and from the curb for garbage pickup. A canvas 10 (see FIG. 5) or other material covering can be attached to the flipped bars to securely cover the top of the cans when the flip bars are in the closed position and to leave the cans 8 uncovered when the cans flip bars 7 are into the open position. The canvas covering top 10 secures the can lids in place preventing raccoons and other animals from going into the cans 8. A pull put pin 11 can be employed as shown in FIG. 5 to adjust the vertical side bar 12 on each side of the caddy frame 5 for different heights of cans 8. A wide plate 13 preferably flat and preferably 20 inches wide is located as shown in FIG. 5 and is taller than the cans 8 to keep animals from gaining access to the cans 8 from the front and rear of the caddy 5. The canvas top 10 can snap onto the flip bars 7 with the use of grommets. This secures the cans 8 without the lids against wind, rain, animals.

The caddy 5 is a wheel mounted storage unit that can hold any number of garbage cans 8 and preferably 2, 3 or 4 cans. The caddy 5 permits the cans 8 to be easily moved to and from curbside. The caddy frame 5 can be made of steel, aluminum, plastic or any available material. The caddy 5 preferably has 4 rubber wheels 9, 2 that swivel located in front and two fixed rear wheels 9 and a pair of flip bars 7 pivot over the top of the caddy frame work 5 when in the up position and allows for loading of the cans into the caddy. When the flip bars 7 are flipped down a waterproof canvas top 10 covers the cans 8. They can not be toppled by scavenging animals or blown over by the wind. The present disclosure provides for a garbage caddy 5 that is easy to use and keeps the garbage neat. The product could be used for residential households or in commercial use. This product is useful for elderly or infirmed people since it doesn't require great strength or coordination to use and operate.

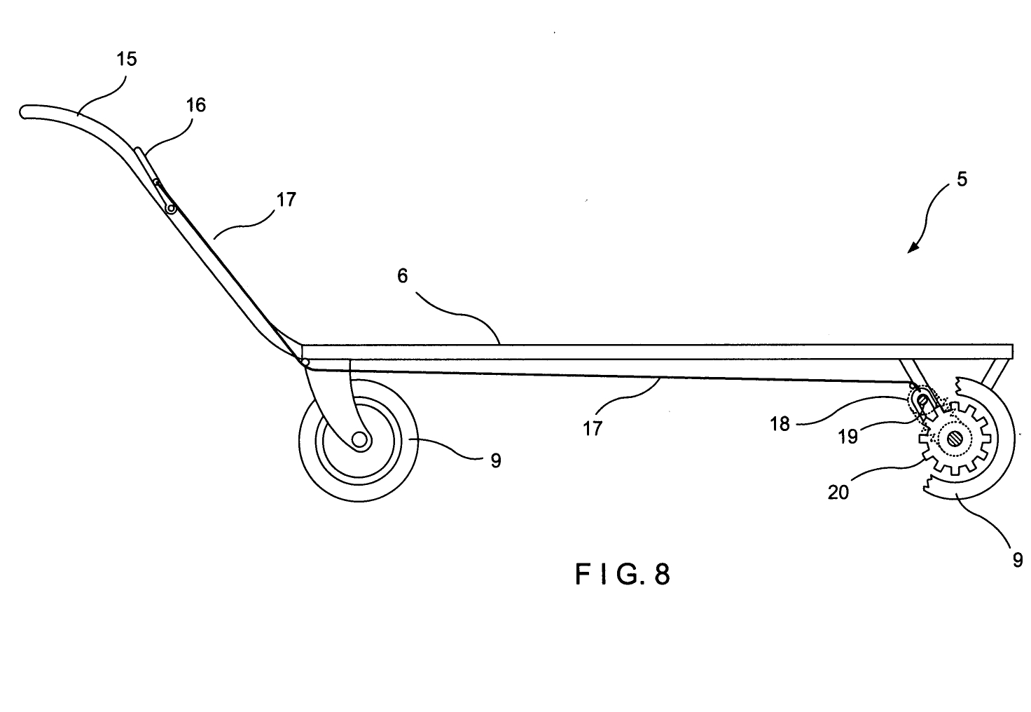

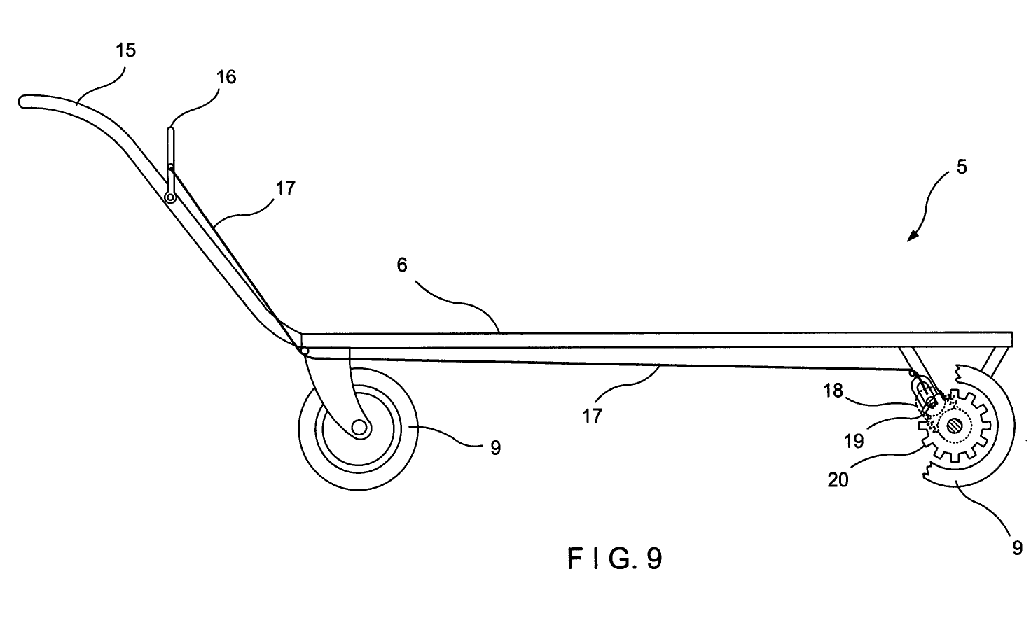

In another embodiment as shown in FIG. 8, a parking brake can be included as an additional feature of the present invention that provides for a brake where the two fixed rear wheels 9 of the frame 5 are located. As shown in the embodiment of FIGS. 8 and 9, a parking brake handle 16 is mounted on to the handle of the frame 5. The parking brake handle 16 is attached to one end of the brake cable 17 which at its other end is attached to a brake bar 18 at the bottom of the frame 5. When the parking brake handle 16 is released, the brake bar 18 has an end 19 that slides into the wheel cog 20 of rear wheel 9 of the frame 5. Springs hold the brake bar 18 in the cog 20. When the brake handle 16 is squeezed against the handle 15 of the frame 5, it pulls on the brake cable 17 and pulls the brake bar 18 out of the wheel cog 20 freeing the rear wheel of the frame 5 for movement, thus unlocking the caddy 5 so it can be rolled. It is understood that the present disclosure is not limited to any one braking system and any known breaking mechanism can be employed for the caddy 5.

While certain embodiments have been shown and described, it is distinctly understood that the invention is not limited thereto but may be otherwise embodied within the scope of the appended claims.

What is claimed:

1. A garbage can caddy for storing garbage cans comprising:
A caddy having a frame with an open top surface and a bottom surface and has wheels below the bottom surface for transporting the cans within the caddy; flip bars are pivotally connected to the frame to lock the cans in place or to release them from the caddy.

2. The garbage caddy according to claim 1 further comprising a canopy attached to the caddy and the flip bars to cover the garbage can tops.

3. The caddy according to claim 2 wherein said canopy is made of canvas material.

4. The caddy according to claim 2 wherein the canopy is attached to the flip bar and closes with the rotational movement of the flip bars in one of two rotational directions of the flip bar with respect to the caddy.

5. The caddy according to claim 4 wherein the canopy is attached to the flip bars by snapping the canopy onto the flip bars with the use of grommets.

6. The caddy according to claim 1 wherein said caddy includes a braking mechanism for locking at least one of the caddy's rear wheels from moving.

7. The caddy according to claim 6 wherein said braking mechanism includes a handle located near a top surface of said caddy.
